(19) United States
(12) Patent Application Publication
(10) Pub. No.: US 2026/0273755 A1
(43) Pub. Date: Sep. 17, 2026

(54) ROBOT VISION SYSTEM

(71) Applicant: NACHI-FUJIKOSHI CORP., Tokyo (JP)

(72) Inventor: Masao SAMBONGI, Toyama (JP)

(73) Assignee: NACHI-FUJIKOSHI CORP., Tokyo (JP)

(21) Appl. No.: 18/440,964

(22) PCT Filed: Jun. 17, 2022
(86) PCT No.: PCT/JP2022/024366

§ 371 Date: Apr. 30, 2026

(30) Foreign Application Priority Data
Jul. 9, 2021 (JP) 2021-114391

(51) Int. Cl. B25J 9/16

(52) U.S. Cl. CPC B25J 9/1697

(57) ABSTRACT

To provide a robot vision system capable of holding a work piece reliably and quickly, and improving work efficiency. A robot vision system of the present invention is the robot vision system including a robot with a camera, the robot vision system including a work space determination device determining a work space in which a work piece can be located, and an operation switching device switching an operation of the robot between a teaching operation and a visual feedback operation, and when an end effector of the robot moves outside of the work space, the operation switching device switches the operation to the teaching operation, and when the end effector moves into the work space, the operation switching device switches the operation to the visual feedback operation.

### FIELD OF THE INVENTION

The present invention relates to a robot vision system including a robot provided with a camera.

### BACKGROUND OF THE INVENTION

In recent years, industrial machines such as robot arms and manipulators are used at production sites such as factories. For example, Patent Document 1 discloses a movement control method for a robot. In Patent Document 1, a tool (end effector) is attached to the end of an arm 11 of a robot 10.

In Patent Document 1, in particular, when the tool 12 approaches a work piece and the work piece enters a field of view of a camera, an image processing device senses the work piece, and a robot controller switches from an ordinary mode to an autonomous approach mode to start an autonomous approach operation. Here, in the ordinary mode, the robot is moved according to a conventional jog operation. On the other hand, in the autonomous approach mode, the robot autonomously moves to a final movement target position of the approach operation, based on approach completion state indication data indicating an approach completion state with respect to an object.

### PRIOR ART DOCUMENT

### Patent Document

Patent Document 1: Japanese Patent No. 3998741

### SUMMARY OF THE INVENTION

### Problems to be Solved by the Invention

According to Patent Document 1, by making it possible to autonomously approach the target position, work efficiency can be improved. However, if a work piece enters the field of view of the camera while away from a tool, from that time, the robot operates in the autonomous approach mode. As a result, it takes time for the robot to arrive at a position where the robot reaches the work piece, that is, a final movement target position, and it is conceivably difficult to dramatically shorten the working hours. For this reason, there is room for improvement in the technique disclosed in Patent Document 1.

In view of the above problems, an object of the present invention is to provide a robot vision system capable of holding a work piece reliably and quickly, and improving work efficiency.

### Means to Solve the Problem

In order to solve the above problems, a representative configuration of a robot vision system according to the present invention is a robot vision system including a robot provided with a camera, the robot vision system including a work space determination device that determines a work space in which a work piece can be located, and an operation switching device that switches an operation of the robot between a teaching operation and a visual feedback operation, and, when an end effector of the robot moves outside of the work space, the operation switching device switches the operation to the teaching operation, and when the end effector moves into the work space, the operation switching device switches the operation to the visual feedback operation.

### Effects of the Invention

According to the present invention, a robot vision system capable of holding a work piece reliably and quickly, and improving work efficiency can be provided.

### BRIEF EXPLANATION OF THE DRAWINGS

FIG. 1 is a schematic diagram illustrating a robot vision system according to the present embodiment.

FIG. 2 is a functional block diagram illustrating an operational configuration of the robot vision system of the present embodiment.

FIG. 3 is a flowchart illustrating operations of the robot vision system of the present embodiment.

### EMBODIMENTS OF THE INVENTION

Preferred embodiments of the present invention will be described in detail below with reference to the accompanying drawings. The dimensions, materials, and other specific numerical values shown in the embodiments are merely examples for facilitating the understanding of the invention, and are not intended to limit the present invention unless otherwise specified. Note that in the present specification and drawings, elements having substantially the same function and configuration are designated by the same reference signs in order to omit redundant descriptions, and elements not directly related to the present invention are not shown.

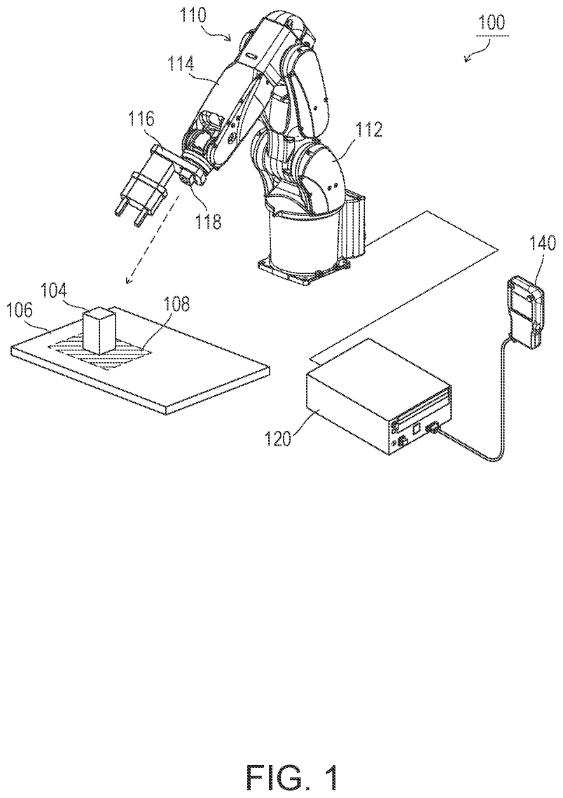

FIG. 1 is a schematic diagram illustrating a robot vision system 100 according to the present embodiment. As shown in FIG. 1, the robot vision system 100 of the present embodiment includes a robot 110 and a controller 120. A teaching pendant 140 is connected to the controller 120. The teaching pendant 140 is a device that allows a user to teach and manually controls a movement of a robot arm 114.

The robot 110 includes a body 112 that supports the arm 114, and an end effector 116 is attached to the end of the arm 114. A camera 118 is attached to the end effector 116. The robot 110 holds a work piece 104 using the end effector 116 and moves the work piece 104 to a predetermined position.

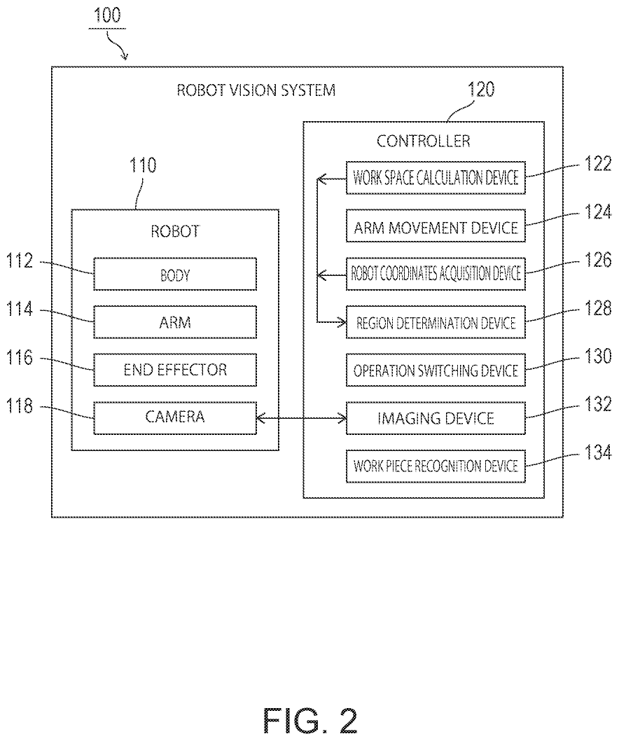

FIG. 2 is a functional block diagram illustrating the functional configuration of the robot vision system 100 of the present embodiment. As shown in FIG. 2, the robot vision system 100 of the present embodiment includes the robot 110 and the controller 120. The controller 120 includes a work space determination device 122, an arm movement device 124, a robot coordinates obtainment device 126, a region determination device 128, an operation switching device 130, an imaging device 132, and a work piece recognition device 134.

As preprocessing, the work space determination device 122 determines a work space 108 that is a range within which the work piece 104 can be located on a work table 106. Specifically, such as by capturing images of the work piece 104 placed at various positions on the work table 106 and by capturing images of a plurality of work pieces 104 placed on the work table 106, the work space 108 can be set based on the imaged data.

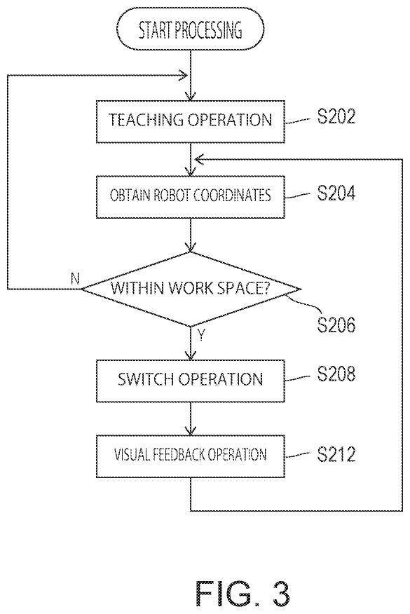

FIG. 3 is a flowchart illustrating the operations of the robot vision system 100 of the present embodiment. Note that, in the present embodiment, a description will be given on the assumption that the end effector 116 of the robot 110 moves from the outside of the work space 108 into the work space 108.

If the end effector 116 of the robot 110 is located outside of the work space at the start of the processing, the arm movement device 124 of the controller 120 operates the arm 114 and the end effector 116 of the robot 110 in accordance with a predetermined program using a teaching operation (S202).

Next, the robot coordinates acquisition device 126 acquires robot coordinates of the end effector 116 (S204). The region determination device 128 refers to the work space 108 determined by the work space determination device 122 and the robot coordinates acquired by the robot coordinates acquisition device 126 to determine whether the end effector 116 of the robot 110 is located within the work space 108 (S206). If the end effector 116 is located outside of the work space 108 (NO in S206), the controller 120 repeats processing of S202 to S206.

If the end effector 116 of the robot 110 is located inside the work space 108 (YES in S206), the movement switching device 130 switches the operation of the robot 110 from the teaching operation to a visual feedback operation (S208). Then, the arm movement device 124 of the controller 120 operates the arm 114 and the end effector 116 of the robot 110 using a visual feedback operation (S212).

In the visual feedback operation, the imaging device 132 of the controller 120 captures images using the camera 110. Then, when the work piece recognition device 134 recognizes the work piece 104 in the image (object recognition), the arm movement device 124 moves the end effector 116 of the robot 110 to the work piece 104 and holds the work 104 with the end effector 116.

After switching to the visual feedback operation (S206 to S212), the processing returns to the robot coordinates obtainment (S204). Then, the controller 120 continuously monitors and determines whether the current position of the end effector 116 of the robot 110 is within the work space 108 (S206). In this manner, if the end effector 116 of the robot 110 moves outside of the work space 108 from the inside of the work space 108, the operation switching device 130 can switch the operation of the robot 110 from the visual feedback operation to the teaching operation.

As described above, in the robot vision system 100 of the present embodiment, the work space 108 that is a range within which the work 104 can be located is set in advance. When the end effector 116 of the robot 110 moves into the work space 108, the operation of the robot 110 is switched from the teaching operation to the visual feedback operation. In this manner, until the end effector 116 moves into the work space 108, the end effector 116 is efficiently moved according to the teaching operation, and when the end effector 116 moves into the work space 108, the operation is switched to the visual feedback operation through which the end effector 116 is precisely controlled. Accordingly, the work piece 104 can be reliably and quickly held, making it possible to improve work efficiency.

While preferred embodiments of the present invention have been described with reference to the attached drawings, it goes without saying that the present invention is not limited to these embodiments and examples. It is clear that those skilled in the art will be able to arrive at various changes and modifications within the scope of the claims, and those changes and modifications are understood to naturally fall within the technical scope of the present invention.

This application is based upon and claims the benefit of priority from the prior Japanese Patent Application No. 2021-114391, filed on Jul. 9, 2021, the above-described contents are cited in the description, claims, and drawings of the application.

### INDUSTRIAL APPLICABILITY

The present invention can be used as a robot vision system including a robot provided with a camera.

### INDEX TO THE REFERENCE NUMERALS

100 . . . Robot vision system; 104 . . . Work piece; 106 . . . Work table; 108 . . . Work space; 110 . . . Robot; 112 . . . Body; 114 . . . Arm; 116 . . . End effector; 118 . . . Camera; 120 . . . controller; 122 . . . Work space calculation device, 124 . . . Arm movement device; 126 . . . Robot coordinates acquisition device; 128 . . . Region determination device; 130 . . . Operation switching device; 132 Imaging device, 134 . . . Work piece recognition device, 140 . . . Teaching pendant

1. A robot vision system including a robot provided with a camera, the robot vision system comprising:
a work space determination device that determines a work space in which a work piece can be located; and
an operation switching device that switches an operation of the robot between a teaching operation and a visual feedback operation,
wherein, when an end effector of the robot moves outside of the work space, the operation switching device switches the operation to the teaching operation, and when the end effector moves into the work space, the operation switching device switches the operation to the visual feedback operation.
